(19) United States
(12) Patent Application Publication
(10) Pub. No.: US 2021/0365887 A1
(43) Pub. Date: Nov. 25, 2021

(54) NEAR-REAL-TIME COLLABORATIVE VEHICLE REPAIR ESTIMATING TOOL

(71) Applicant: Mitchell International, Inc., San Diego, CA (US)

(72) Inventors: Niv Genchel, San Diego, CA (US); Ravi Kiran Nemani, Carlsbad, CA (US)

(73) Assignee: Mitchell International, Inc., San Diego, CA (US)

(21) Appl. No.: 16/881,884

(22) Filed: May 22, 2020

(51) Int. Cl. G06Q 10/10; G06Q 30/02

(52) U.S. Cl. CPC G06Q 10/103; G06Q 40/08; G06Q 30/0283

(57) ABSTRACT

A near-real-time collaborative vehicle repair estimating tool is provided. In general, one aspect disclosed features a system, comprising: a hardware processor; and a non-transitory machine-readable storage medium encoded with instructions executable by the hardware processor to perform a method comprising: providing at least one view of a repair estimate record to a plurality of client devices; receiving a revision of the repair estimate record from one of the client devices; generating a revised repair estimate record by revising the repair estimate record according to the received revision responsive to receiving the revision of the repair estimate record; and providing at least one view of the revised repair estimate record to the plurality of client devices in near real time with receiving the revision of the repair estimate record.

### DESCRIPTION OF RELATED ART

The disclosed technology relates generally to systems for estimating vehicle repairs, and more particularly, some embodiments relate to a systems and methods for implementing the same.

### SUMMARY

In general, one aspect disclosed features a system, comprising: a hardware processor; and a non-transitory machine-readable storage medium encoded with instructions executable by the hardware processor to perform a method comprising: providing at least one view of a repair estimate record to a plurality of client devices; receiving a revision of the repair estimate record from one of the client devices; generating a revised repair estimate record by revising the repair estimate record according to the received revision responsive to receiving the revision of the repair estimate record; and providing at least one view of the revised repair estimate record to the plurality of client devices in near real time with receiving the revision of the repair estimate record.

Embodiments of the method may include one or more of the following features. In some embodiments, the method further comprises: receiving respective second revisions of the revised repair estimate record from two or more of the client devices concurrently, wherein each of the second revisions is associated with a respective field of the revised repair estimate record; responsive to receiving the second revisions, generating a second revised repair estimate record by revising the repair estimate record, comprising revising the respective fields of the revised repair estimate record concurrently according to the second revisions; and providing at least one view of the second revised repair estimate record to the plurality of client devices concurrently and in near real time with receiving the second revisions. In some embodiments, the method further comprises: highlighting the revision as a being a proposed revision in the at least one view of the revised repair estimate record provided to the plurality of client devices in near real time with receiving the revision of the repair estimate record. In some embodiments, the method further comprises: receiving, from a second one of the client devices, an approval of the revision; and responsive to receiving the approval, committing the revision in the repair estimate record. In some embodiments, the method further comprises: receiving, from a second one of the client devices, a rejection of the revision; and responsive to receiving the rejection, revising the estimate record to remove the revision. In some embodiments, the method further comprises: determining a role of a user of one of the client devices; receiving an input from the one of the client devices; and modifying the repair estimate record according to the received input only when the received input is permitted by the role of the user. In some embodiments, the method further comprises: generating the repair estimate record based on inputs provided by one of the users.

In general, one aspect disclosed features a non-transitory machine-readable storage medium encoded with instructions executable by a hardware processor of a computing component, the machine-readable storage medium comprising instructions to cause the hardware processor to perform a method comprising: providing at least one view of a repair estimate record to a plurality of client devices; receiving a revision of the repair estimate record from one of the client devices; generating a revised repair estimate record by revising the repair estimate record according to the received revision responsive to receiving the revision of the repair estimate record; and providing at least one view of the revised repair estimate record to the plurality of client devices in near real time with receiving the revision of the repair estimate record.

Embodiments of the non-transitory machine-readable storage medium may include one or more of the following features. In some embodiments, the method further comprises: receiving respective second revisions of the revised repair estimate record from two or more of the client devices concurrently, wherein each of the second revisions is associated with a respective field of the revised repair estimate record; responsive to receiving the second revisions, generating a second revised repair estimate record by revising the repair estimate record, comprising revising the respective fields of the revised repair estimate record concurrently according to the second revisions; and providing at least one view of the second revised repair estimate record to the plurality of client devices concurrently and in near real time with receiving the second revisions. In some embodiments, the method further comprises: highlighting the revision as a being a proposed revision in the at least one view of the revised repair estimate record provided to the plurality of client devices in near real time with receiving the revision of the repair estimate record. In some embodiments, the method further comprises: receiving, from a second one of the client devices, an approval of the revision; and responsive to receiving the approval, committing the revision in the repair estimate record. In some embodiments, the method further comprises: receiving, from a second one of the client devices, a rejection of the revision; and responsive to receiving the rejection, revising the estimate record to remove the revision. In some embodiments, the method further comprises: determining a role of a user of one of the client devices; receiving an input from the one on the client devices; and modifying the repair estimate record according to the received input only when the received input is permitted by the role of the user. In some embodiments, the method further comprises: generating the repair estimate record based on inputs provided by one of the users.

In general, one aspect disclosed features a method implemented by a server computer, the method comprising: providing at least one view of a repair estimate record to a plurality of client devices; receiving a revision of the repair estimate record from one of the client devices; generating a revised repair estimate record by revising the repair estimate record according to the received revision responsive to receiving the revision of the repair estimate record; and providing at least one view of the revised repair estimate record to the plurality of client devices in near real time with receiving the revision of the repair estimate record.

Embodiments of the method may include one or more of the following features. Some embodiments comprise receiving respective second revisions of the revised repair estimate record from two or more of the client devices concurrently, wherein each of the second revisions is associated with a respective field of the revised repair estimate record; responsive to receiving the second revisions, generating a second revised repair estimate record by revising the repair estimate record, comprising revising the respective fields of the revised repair estimate record concurrently according to the second revisions; and providing at least one view of the second revised repair estimate record to the plurality of client devices concurrently and in near real time with receiving the second revisions. Some embodiments comprise highlighting the revision as being a proposed revision in the at least one view of the revised repair estimate record provided to the plurality of client devices in near real time with receiving the revision of the repair estimate record. Some embodiments comprise receiving, from a second one of the client devices, an approval of the revision; and responsive to receiving the approval, committing the revision in the repair estimate record. Some embodiments comprise receiving, from a second one of the client devices, a rejection of the revision; and responsive to receiving the rejection, revising the estimate record to remove the revision. Some embodiments comprise determining a role of a user of one of the client devices; receiving an input from the one on the client devices; and modifying the repair estimate record according to the received input only when the received input is permitted by the role of the user.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a near-real-time collaborative vehicle repair estimating system according to some embodiments of the disclosed technology.

FIG. 2 illustrates a process for a vehicle repair cycle including near-real-time collaborative repair estimation according to some embodiments of the disclosed technology.

FIG. 3A,B illustrate a process for the near-real-time collaborative repair estimation according to some embodiments of the disclosed technology.

FIG. 4 illustrates a process for near-real-time concurrent repair estimate record modification according to some embodiments of the disclosed technology.

FIG. 5 illustrates a job overview generated by the near-real-time tool according to some embodiments of the disclosed technology.

FIG. 6 illustrates a repair estimate view generated by the near-real-time tool according to some embodiments of the disclosed technology.

FIG. 7 illustrates a repair estimate reviewing view generated by the near-real-time tool according to some embodiments of the disclosed technology.

FIG. 8 illustrates a repair estimate committing view generated by the near-real-time tool according to some embodiments of the disclosed technology.

FIG. 9 is an example computing component that may be used to implement various features of embodiments described in the present disclosure.

The figures are not exhaustive and do not limit the present disclosure to the precise form disclosed.

### DETAILED DESCRIPTION

With the advent of high-power, cost effective computing systems came the increased automation of numerous facets of our contemporary society. In the insurance and other casualty and loss industries, for example, computerized claims estimating, processing, tracking and payment systems have long been in use to streamline the process and to expedite claims handling and closure.

Despite these advances, due to its collaborative nature, the generation of claims estimates remains a long and tedious process, requiring input and review from multiple parties involved in the estimating process. A conventional estimating process begins with one party, for example an estimator in a repair shop, generating an estimate. The estimate is then forwarded to a second party, for example a claims adjuster for an insurer, for review and possible modification. Any modifications by one party must be forwarded to another party for review and approval. The generation of a final estimate may involve a number of these review, modification, forwarding, and approval cycles, which may be applied by multiple authors and reviewers of the estimate. For these reasons, conventional estimating processes consume significant portion of the repair cycle time.

Embodiments of the disclosed technology provide a near-real-time collaborative vehicle repair estimating tool which overcomes these difficulties. Rather than being implemented as multiple instances deployed at multiple customer sites, the tool may be implemented in a cloud deployment such that multiple users may access an estimate concurrently. In some embodiments, a change made to the estimate by one user is immediately made available to other users. In some embodiments, multiple users may change different parts of the estimate concurrently. In some embodiments, a proposed change may be shown in a highlighted manner to draw the attention of other users to the proposed change. These and other embodiments and features are described below.

In this description, various embodiments are disclosed for generating estimates for vehicle repairs. However, embodiments of the disclosed technology apply to the generation of any type of estimate that requires the collaboration of multiple parties. For example, embodiments may apply to generating estimates for medical procedures, and the like. These and other applications will be apparent to one skilled in the relevant art after reading this description.

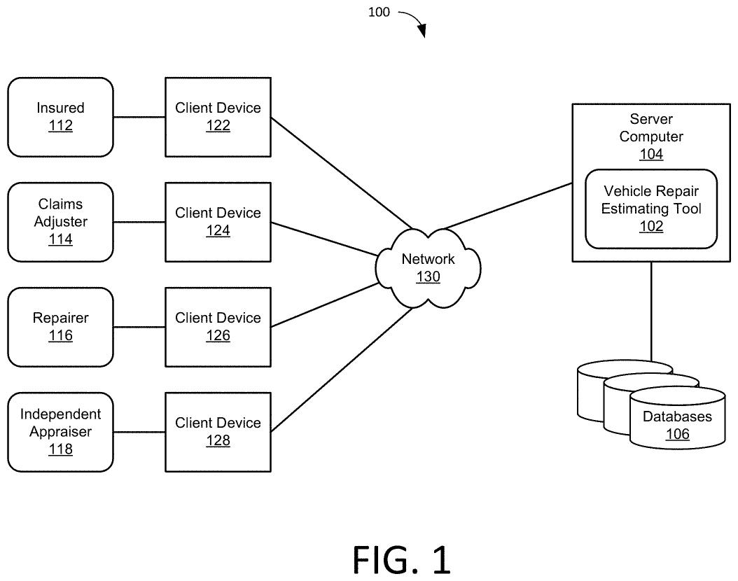

FIG. 1 illustrates a near-real-time collaborative vehicle repair estimating system 100 according to some embodiments of the disclosed technology. Referring to FIG. 1, the system 100 includes a near-real-time collaborative vehicle repair estimating tool 102, which may be implemented as one or more software packages executing on one or more server computers 104. The system may include one or more databases 106, which may store completed estimates, estimates in process, data regarding parts, part costs, labor, labor costs, and the like. The near-real-time tool 102 may access the databases 106 over either a public or private network.

Multiple users may be involved in the estimating process. For example, users may include the insured 112, a claims adjuster 114, a repairer 116 such as an employee of a repair shop, an independent appraiser 118, and the like. Each user may access the near-real-time tool 102 over the network 130 using a respective client device 122, 124, 126, 128. Each client device may be implemented as a desktop computer, laptop computer, smart phone, smart glasses, embedded computers and displays, diagnostic devices and the like.

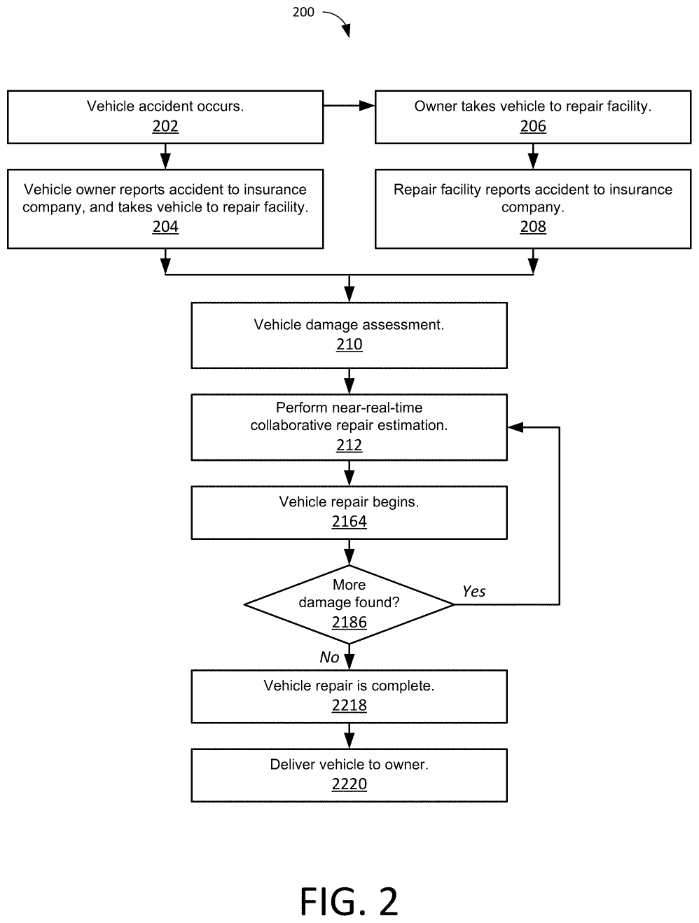

FIG. 2 illustrates a process 200 for a vehicle repair cycle including near-real-time collaborative repair estimation according to some embodiments of the disclosed technology. Referring to FIG. 2, the process 200 may begin with a vehicle accident, at 202, and may continue with the vehicle owner reporting the accident to an insurance company, and taking the vehicle to a repair facility, at 204. Alternatively, the owner may take the vehicle to a repair facility, at 206, which may report the accident to the insurance company, at 208.

Next, a vehicle damage assessment is performed, at 210. For example, a staff appraiser of an insurance company may visit the damaged vehicle to take photos and assess the damage. Alternatively, the owner may send photos of the damaged vehicle to the insurance company. Next, the process may include the near-real-time collaborative repair estimation, at 210, as discussed in detail in this description. This near-real-time collaboration may involve the generation, of a repair estimate record, followed by multiple rounds of revision and review. Based on this assessment, the appraiser may generate a repair estimate record. As used herein, the term “record” may refer to an electronic document, or the like.

The vehicle may be taken to an auto repair shop, where an employee may further assess the damage, and may revise the estimate by using a desktop computer to revise the repair estimate record. An insurance staff employee may review the revised record, and accept or reject revisions made by the auto repair shop employee. The auto repair shop employee may accept or reject revisions made by the insurance staff employee. This near-real-time collaboration process may be repeated as many times as needed.

The insurance company may also send an independent appraiser to further assess the damage on the vehicle. The insurance company staff appraiser and the independent appraiser may collaborate in near real time to revise the estimate, for example by making further revisions and by accepting or rejecting those revisions. These are merely examples. Any group of 2 or more users may collaborate in near real time to revise the repair estimate.

When the users collaborating on the repair estimate agree, one of the users may commit the repair estimate. After the repair estimate is committed, the repair of the vehicle may begin, at 214. During the repair of the vehicle, more damage may be found, at 216. If more damage is found, the process 200 may return to near-real-time collaborative repair estimation, at 210, for example by generating a supplement estimate. When no additional damages are found, at 216, the repair of the vehicle may be completed, at 218, and the repaired vehicle may be delivered to the vehicle owner, at 220.

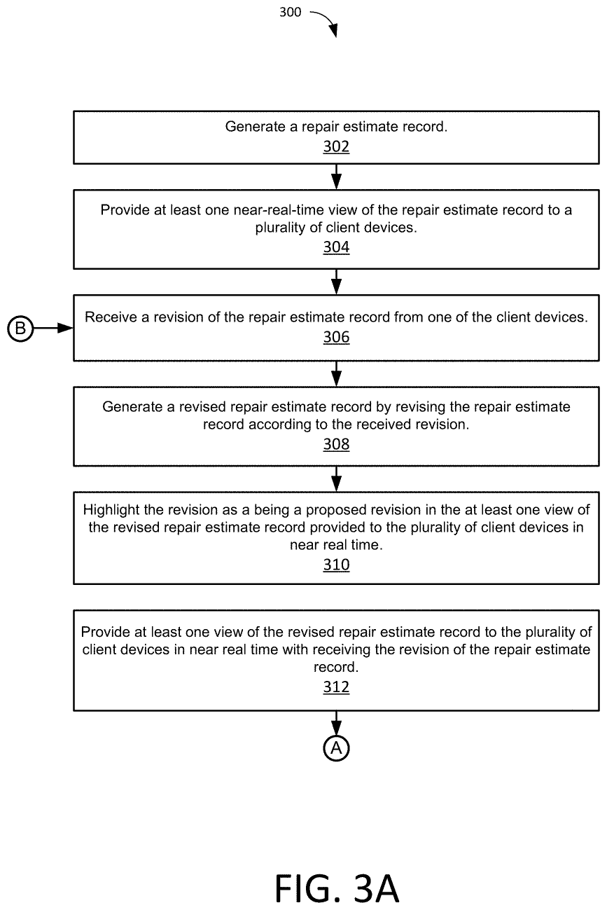

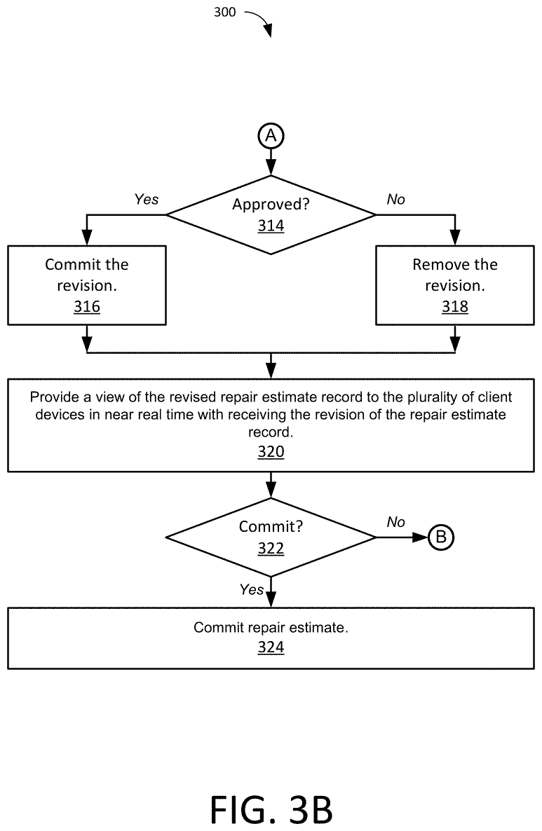

FIG. 3A,B illustrate a process 300 for the near-real-time collaborative repair estimation according to some embodiments of the disclosed technology. The process 300 may begin with a user generating a repair estimate record using one of the client devices, at 302. For example, the user may be an insurance claims adjuster, and the client device may be the adjuster's smart phone. The user may employ the client device to cause the near-real-time tool 102 to create a new repair estimate record by selecting a particular repair estimate template, and may generate the repair estimate record by adding one or more repair lines to the new repair estimate record. Each repair line may represent a phase of the vehicle repair. For example, one line might represent repair of the vehicle bumper, while another line may represent replacements of a headlamp assembly.

Responsive to the generation of the estimate record, the collaborative vehicle repair estimating tool 102 may provide at least one near-real-time view of the repair estimate record to a plurality of the client devices, at 304. In this manner, multiple users may view the repair estimate record in near real time. And because the views are near-real-time deals, users may view the repair estimate record while it is being created. For example, when the claims adjuster enters a new line into the estimate, the near-real-time views provided to the client devices may be updated to show that new line.

In some embodiments, the near-real-time views provided to the client devices may be updated more frequently. For example, the near-real-time views may be substantially the same as the view seen by the auto repair shop employee. In these embodiments, the users can see every action performed by the auto repair shop employee.

In addition to viewing the estimate in near real time, users may also revise the estimate in near real time. That is, the user may employ a client device to submit a revision to the estimate. The near-real-time tool 102 may receive the revision to the repair estimate record from the client device, at 306. Responsive to receiving the revision, the near-real-time tool 102 may generate a revised repair estimate record by revising the repair estimate record according to the received revision, at 308. In some embodiments, the near-real-time tool 102 may highlight the revision in the record and/or the view provided to the client devices, at 310. This highlighting serves to draw the users' attention to the revision. The near-real-time tool 102 then provides at least one view of the revised repair estimate record to the plurality of client devices in near real time with receiving the revision of the repair estimate record, at 312.

In some embodiments, each time a repair estimate record is revised, the near-real-time tool 102 sends notifications to the client devices. In response to receiving a notification, each client device may generate a pop-up window to show the notification or use icons, fonts, styles or like means to alert the user of the device to changes made. In some embodiments, notifications for a particular repair estimate record are shown only when the user is not viewing that particular repair estimate record.

One or more of the users may approve or reject the revision, at 314. Responsive to a user approving the revision, the near-real-time tool 102 may commit the revision to the estimate, at 316. Alternatively, responsive to a user rejecting the revision, the near-real-time tool 102 may remove the revision from the estimate, at 318. In either case, the near-real-time tool 102 provides at least one view of the repair estimate record to the plurality of client devices in near real time, at 320. At this point one of the users may use a client device to send a request to commit the repair estimate to the near-real-time tool 102, at 322. One of the users may use a client device to grant the request to commit. Responsive to receiving a grant to commit, the near-real-time tool 102 may commit the repair estimate, at 324. But if no grant is received, the near-real-time tool 120 may wait for a further revision of the repair estimate record, returning to 306. The system may be configured to allow the ability to commit without receiving the grant to commit as well.

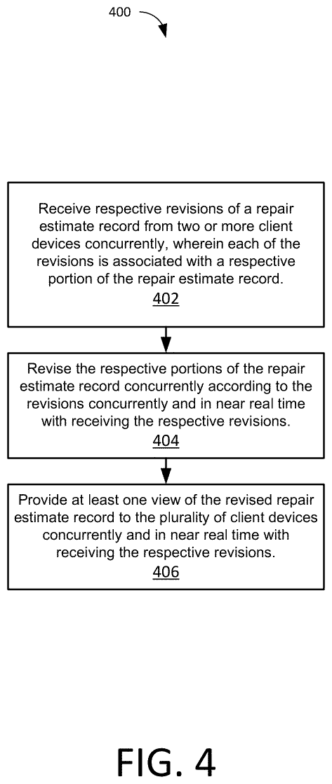

In some embodiments, the near-real-time tool 102 may allow multiple users to revise and approve a single repair estimate record concurrently. FIG. 4 illustrates a process 400 for near-real-time concurrent repair estimate record modification according to some embodiments of the disclosed technology. Referring to FIG. 4, the near-real-time tool 102 may receive respective revisions of a repair estimate record from two or more client devices concurrently, at 402. In some embodiments, the near-real-time tool may not allow multiple users to edit the same portion of the repair estimate record concurrently. For example, the near-real-time tool 102 may not allow multiple users to edit the same line or field of the repair estimate record. In these embodiments, each of the respective revisions is associated with the respective portion of the repair estimate record.

In response to receiving the multiple concurrent revisions to the repair estimate record, the near-real-time tool 102 may revise the respective portions of the repair estimate record concurrently according to those revisions and in near real time with receiving the respective revisions, at 404. For example, one user may submit a revision to one line of the repair estimate record, while another user submits to another line of the repair estimate record. That is, the near-real-time tool 102 may allow the two users to edit the repair estimate record concurrently. In this example, the near-real-time tool 102 may revise both lines of the repair estimate record concurrently.

The near-real-time tool 102 may provide at least one view of the revised repair estimate record to the plurality of client devices concurrently and in near real time with receiving the respective revisions, at 406. In some embodiments, the near-real-time tool 102 may update the views when one of the revisions is complete. For example, near-real-time tool 102 may update the views whenever the revision of a field line, or the like is completed. In other embodiments, the near-real-time tool may update the views as the revisions are taking place. For example, the views may show every action performed by the user revising the repair estimate record, and may display which user is taking the action

In some embodiments, the near-real-time tool may allow any user to revise the estimate, approve or reject a revision, commit the estimate, and create a supplement estimate. In other embodiments, each user may have one or more roles, and the near-real-time tool permits each user to perform only those actions that are permitted by the user's role(s). For example, an auto repair shop employee may have an “initiating” role that permits the employee to generate new repair estimate records. Users not having the “initiating” role are not permitted to generate new repair estimate records. As another example, a “revising” role may permit a user to submit revisions to a repair estimate record. As another example, an “approving” role may permit a user to approve revisions submitted to a repair estimate record. As still another example, a “read only” role may restrict a user to viewing a repair estimate record. As mentioned above, the user may have multiple roles. For example, two users may have both the “revising” and “approving” roles. In this example, either user may submit a revision for the other user to approve or reject. In some of these embodiments, the user may not employ both of these roles with respect to the same revision. That is, the user may not approve the user's own revisions. In some embodiments, the near-real-time tool 102 may allow changes to any type of data and data field in the repair estimate record. In such embodiments, one or more of the roles may restrict access to certain data types, data fields, and the like.

In some embodiments, the near-real-time tool 102 permits users to communicate while collaborating on an estimate. For example, the near-real-time tool 102 may include a chat or video chat function or the like. But in such embodiments, any decision regarding the estimate should be entered using the revision processes described above.

In some embodiments, the near-real-time tool permits users to request review of the changes. These requests may be communicated as notifications, for example according to the notification processes described above.

In some embodiments, the near-real-time tool 102 may employ versioning and/or attribution. For example, multiple versions of each estimate may be maintained, and each revision may be tagged to the user that made the revision. In these examples, the near-real-time tool 102 allows users to roll back to a previous version of an estimate, and to re-apply previous changes.

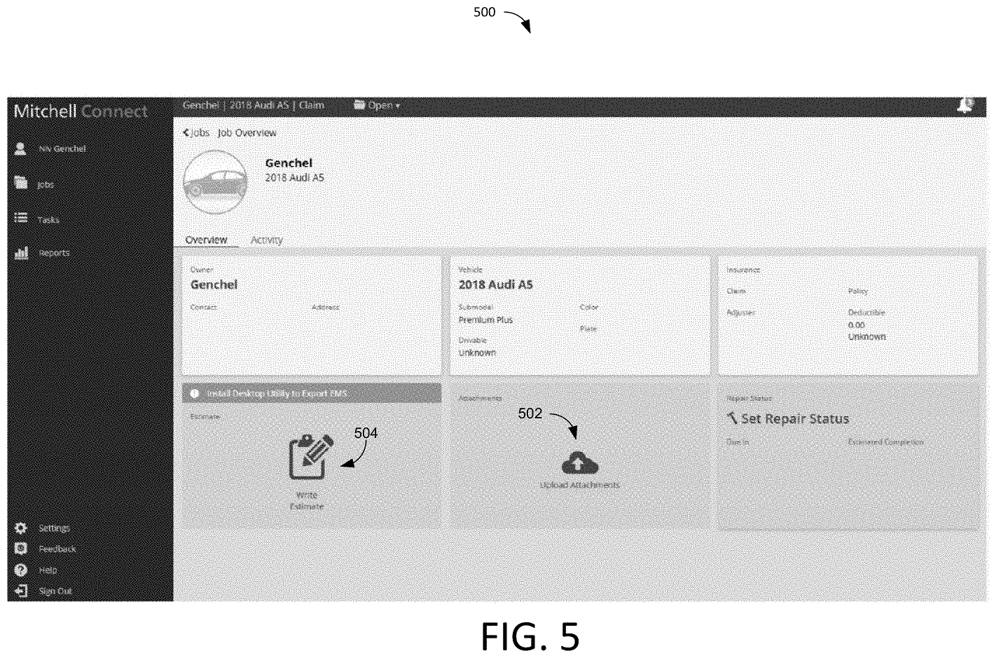

Now several views provided by the near-real-time tool 102 are illustrated and discussed. FIG. 5 illustrates a job overview 500 generated by the near-real-time tool 102 according to some embodiments of the disclosed technology. Referring to FIG. 5, the job overview 500 provides information describing the vehicle, the vehicle owner, the vehicle owner's insurance policy, the repair status of the vehicle, any attachments associated with the estimate, and the like. The vehicle owner information may include the vehicle owner's name, address, contact information, and the like. The vehicle information may include the year, make, and model of the vehicle, as well as the submodel, color, license plate number, whether the vehicle is drivable, and the like. The insurance information may include the policy number, claim number, deductible amounts, contact information for the claim adjuster, and the like. The repair status information may include when the vehicle is due into the auto repair shop, when the repair is estimated to be complete, and the like. The attachments may include photos of the vehicle, a summary of the owner's insurance policy, and the like. In this example, no attachments have been uploaded. The near-real-time tool 102 allows a user to upload attachments by clicking the “Upload Attachments” button, at 502. The near-real-time tool 102 also allows a user to begin writing an estimate, by clicking the “Write Estimate” button, at 504.

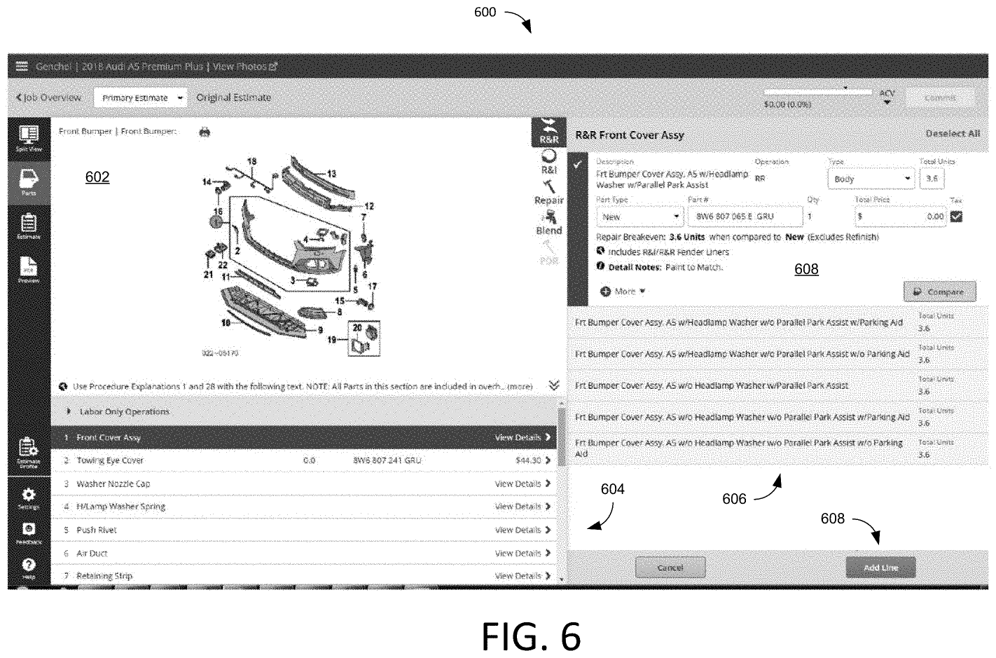

FIG. 6 illustrates a parts selection view 600 generated by the near-real-time tool 102 according to some embodiments of the disclosed technology. This view 600 allows a user to select parts for the vehicle repair, such as a bumper, bumper cover, lamp, and the like, at 604. In view 600, the user has selected the “Front Cover Assay”. In response to this selection, the near-real-time tool 102 shows options for the selected part, at 606. For example, a bumper may come with or without a fog light, for a total of two options. An image of the parts involved in the repair estimate is shown at 602. The user may add additional lines to the repair estimate by clicking the “Add Line” button 608.

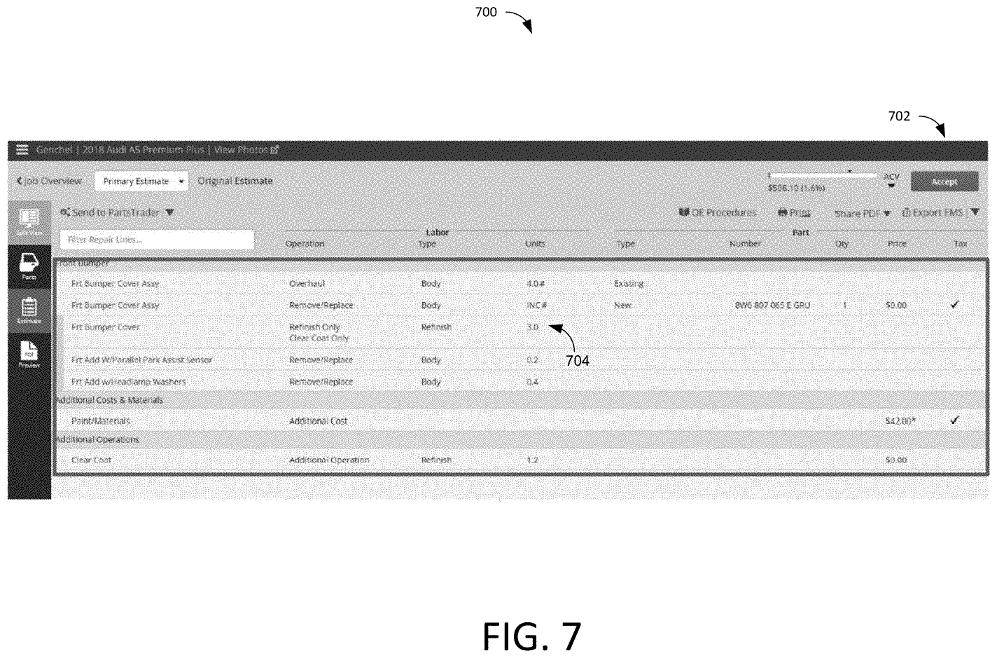

FIG. 7 illustrates a repair estimate reviewing view 700 generated by the near-real-time tool 102 according to some embodiments of the disclosed technology. In this view 700, the user may accept the estimate by clicking the “Accept” button 702. However, in this example, the user has decided the number of units “3.0” in the “Front Bumper Cover” is incorrect, at 704.

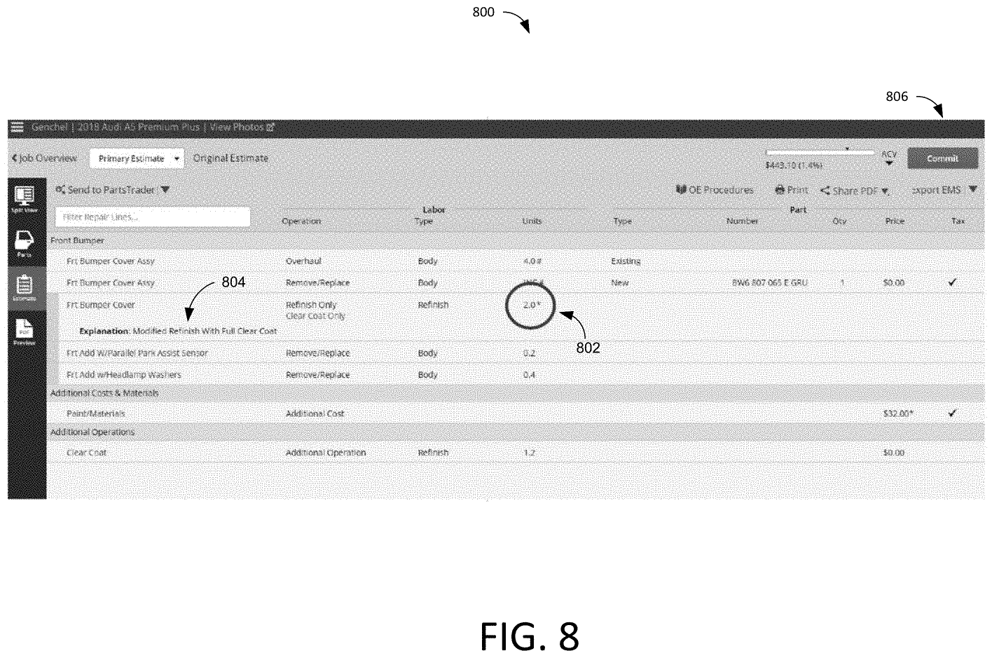

FIG. 8 illustrates a repair estimate committing view 800 generated by the near-real-time tool 102 according to some embodiments of the disclosed technology. In this view 800, the user has revised the estimate to change the number of units in the “Front Bumper Cover” line from “3.0” to “2.0”, at 802. The user has also added an explanation for the revision, at 804. In this view 800, the user may commit the estimate, at 806.

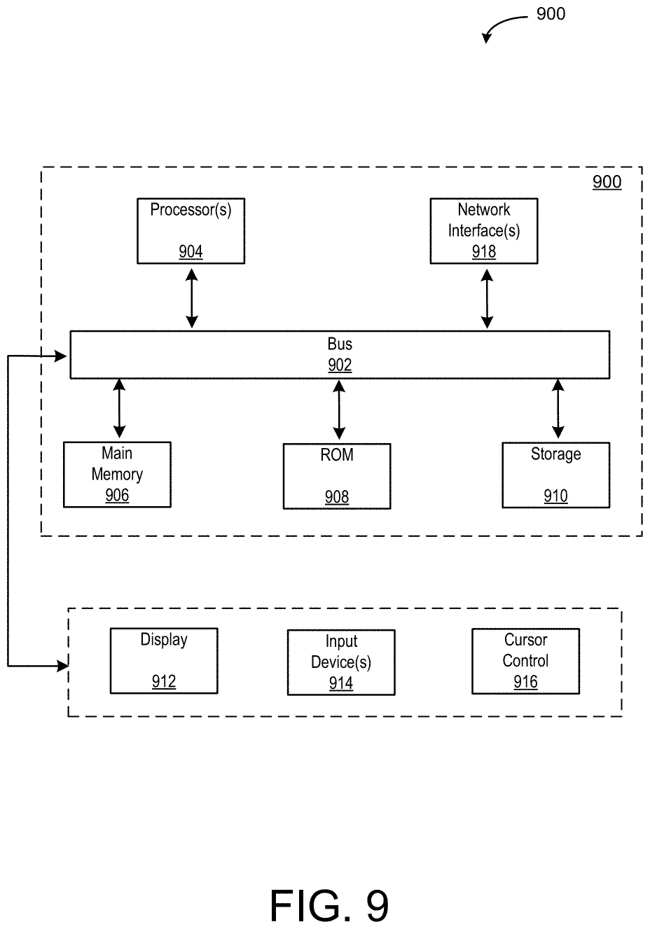

FIG. 9 depicts a block diagram of an example computer system 900 in which embodiments described herein may be implemented. The computer system 900 includes a bus 902 or other communication mechanism for communicating information, one or more hardware processors 904 coupled with bus 902 for processing information. Hardware processor(s) 904 may be, for example, one or more general purpose microprocessors.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

The computer system 900 may be coupled via bus 902 to a display 912, such as a liquid crystal display (LCD) (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. In some embodiments, the same direction information and command selections as cursor control may be implemented via receiving touches on a touch screen without a cursor.

The computing system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

The computer system 900 also includes a communication interface 918 coupled to bus 902. Network interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or a WAN component to communicate with a WAN). Wireless links may also be implemented. In any such implementation, network interface 918 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 918, which carry the digital data to and from computer system 900, are example forms of transmission media.

The computer system 900 can send messages and receive data, including program code, through the network(s), network link and communication interface 918. In the Internet example, a server might transmit a requested code for an application program through the Internet, the ISP, the local network and the communication interface 918.

The received code may be executed by processor 904 as it is received, and/or stored in storage device 910, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system XYZ00.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
a hardware processor; and
a non-transitory machine-readable storage medium encoded with instructions executable by the hardware processor to perform a method comprising:
providing at least one view of a repair estimate record to a plurality of client devices;
receiving a revision of the repair estimate record from one of the client devices;
generating a revised repair estimate record by revising the repair estimate record according to the received revision responsive to receiving the revision of the repair estimate record; and
providing at least one view of the revised repair estimate record to the plurality of client devices in near real time with receiving the revision of the repair estimate record.

2. The system of claim 1, the method further comprising:
receiving respective second revisions of the revised repair estimate record from two or more of the client devices concurrently, wherein each of the second revisions is associated with a respective field of the revised repair estimate record;
responsive to receiving the second revisions, generating a second revised repair estimate record by revising the repair estimate record, comprising revising the respective fields of the revised repair estimate record concurrently according to the second revisions; and
providing at least one view of the second revised repair estimate record to the plurality of client devices concurrently and in near real time with receiving the second revisions.

3. The system of claim 1, the method further comprising:
highlighting the revision as a being a proposed revision in the at least one view of the revised repair estimate record provided to the plurality of client devices in near real time with receiving the revision of the repair estimate record.

4. The system of claim 1, the method further comprising:
receiving, from a second one of the client devices, an approval of the revision; and
responsive to receiving the approval, committing the revision in the repair estimate record.

5. The system of claim 1, the method further comprising:
receiving, from a second one of the client devices, a rejection of the revision; and
responsive to receiving the rejection, revising the estimate record to remove the revision.

6. The system of claim 1, the method further comprising:
determining a role of a user of one of the client devices;
receiving an input from the one of the client devices; and
modifying the repair estimate record according to the received input only when the received input is permitted by the role of the user.

7. The system of claim 1, the method further comprising:
generating the repair estimate record based on inputs provided by one of the users.

8. A non-transitory machine-readable storage medium encoded with instructions executable by a hardware processor of a computing component, the machine-readable storage medium comprising instructions to cause the hardware processor to perform a method comprising:
providing at least one view of a repair estimate record to a plurality of client devices;
receiving a revision of the repair estimate record from one of the client devices;
generating a revised repair estimate record by revising the repair estimate record according to the received revision responsive to receiving the revision of the repair estimate record; and
providing at least one view of the revised repair estimate record to the plurality of client devices in near real time with receiving the revision of the repair estimate record.

9. The non-transitory machine-readable storage medium of claim 8, the method further comprising:
receiving respective second revisions of the revised repair estimate record from two or more of the client devices concurrently, wherein each of the second revisions is associated with a respective field of the revised repair estimate record;
responsive to receiving the second revisions, generating a second revised repair estimate record by revising the repair estimate record, comprising revising the respective fields of the revised repair estimate record concurrently according to the second revisions; and
providing at least one view of the second revised repair estimate record to the plurality of client devices concurrently and in near real time with receiving the second revisions.

10. The non-transitory machine-readable storage medium of claim 8, the method further comprising:
highlighting the revision as a being a proposed revision in the at least one view of the revised repair estimate record provided to the plurality of client devices in near real time with receiving the revision of the repair estimate record.

11. The non-transitory machine-readable storage medium of claim 8, the method further comprising:
receiving, from a second one of the client devices, an approval of the revision; and
responsive to receiving the approval, committing the revision in the repair estimate record.

12. The non-transitory machine-readable storage medium of claim 8, the method further comprising:
receiving, from a second one of the client devices, a rejection of the revision; and
responsive to receiving the rejection, revising the estimate record to remove the revision.

13. The non-transitory machine-readable storage medium of claim 8, the method further comprising:
determining a role of a user of one of the client devices;
receiving an input from the one on the client devices; and
modifying the repair estimate record according to the received input only when the received input is permitted by the role of the user.

14. The non-transitory machine-readable storage medium of claim 8, the method further comprising:
generating the repair estimate record based on inputs provided by one of the users.

15. A method implemented by a server computer, the method comprising:
providing at least one view of a repair estimate record to a plurality of client devices;
receiving a revision of the repair estimate record from one of the client devices;
generating a revised repair estimate record by revising the repair estimate record according to the received revision responsive to receiving the revision of the repair estimate record; and
providing at least one view of the revised repair estimate record to the plurality of client devices in near real time with receiving the revision of the repair estimate record.

16. The method of claim 15, further comprising:
receiving respective second revisions of the revised repair estimate record from two or more of the client devices concurrently, wherein each of the second revisions is associated with a respective field of the revised repair estimate record;
responsive to receiving the second revisions, generating a second revised repair estimate record by revising the repair estimate record, comprising revising the respective fields of the revised repair estimate record concurrently according to the second revisions; and
providing at least one view of the second revised repair estimate record to the plurality of client devices concurrently and in near real time with receiving the second revisions.

17. The method of claim 15, further comprising:
highlighting the revision as being a proposed revision in the at least one view of the revised repair estimate record provided to the plurality of client devices in near real time with receiving the revision of the repair estimate record.

18. The method of claim 15, further comprising:
receiving, from a second one of the client devices, an approval of the revision; and
responsive to receiving the approval, committing the revision in the repair estimate record.

19. The method of claim 15, further comprising:
receiving, from a second one of the client devices, a rejection of the revision; and
responsive to receiving the rejection, revising the estimate record to remove the revision.

20. The method of claim 15, further comprising:
determining a role of a user of one of the client devices;
receiving an input from the one on the client devices; and
modifying the repair estimate record according to the received input only when the received input is permitted by the role of the user.
